(19) United States
(12) Patent Application Publication
(10) Pub. No.: US 2023/0116637 A1
(43) Pub. Date: Apr. 13, 2023

(54) PARTICLE SEPARATOR FOR CLEANING A GAS STREAM LOADED WITH PARTICLES

(71) Applicant: WOCO Industrietechnik GmbH, Bad Soden-Salmünster (DE)

(72) Inventor: Sebastian Fenske, Gelnhausen (DE)

(73) Assignee: WOCO Industrietechnik GmbH, Bad Soden-Salmünster (DE)

(21) Appl. No.: 17/937,035

(22) Filed: Sep. 30, 2022

(30) Foreign Application Priority Data
Oct. 1, 2021 (DE) 102021125569.4

(51) Int. Cl. B01D 45/08; F01M 13/04; H01M 8/0258

(52) U.S. Cl. CPC B01D 45/08; F01M 13/04; H01M 8/0258; F01M 2013/0433

(57) ABSTRACT

A particle separator for cleaning a gas stream loaded with particles may include a gas stream inlet at which the gas stream enters the particle separator with an inflow direction, a gas stream outlet at which the gas stream leaves the particle separator, a closed state in which gas flow from the gas stream inlet to the gas stream outlet is prevented except for a leakage flow, at least one opening condition in which, in addition to the leakage flow, a large volume flow is permitted from the gas stream inlet to the gas stream outlet, a deflection guide between the gas stream inlet and the gas stream outlet, which deflects the large volume flow and/or the leakage flow with respect to the inflow direction, and a textile arranged such that at least part of the deflected large-volume flow and/or the deflected leakage flow impinges on the textile.

### CROSS REFERENCE TO RELATED APPLICATIONS

This patent application claims priority to German Patent Application No. 102021125569.4, filed Oct. 1, 2021, which is incorporated herein by reference in its entirety.

### BACKGROUND

### Field

The present disclosure relates to a particle separator for cleaning a gas stream loaded with particles, such as fluid particles. In particular, the particle separator can be used for cleaning an anode stream of a fuel cell loaded with water particles and/or blow-by gas of a crankcase ventilation of a motor vehicle engine loaded with oil particles. The disclosure further relates to a particle separation system comprising two particle separators in fluid communication with one another. In addition, the disclosure relates to a method of cleaning a particulate laden gas stream with the particle separator or the particle separator system. Furthermore, the disclosure relates to a fuel cell system with the particle separator and a fuel cell vehicle as well as a crankcase ventilation system for a motor vehicle.

### Related Art

Conventional particle separators can include two types of separators, including active separators and passive separators. Active separators are characterized by additional energy being applied to the particles in order to achieve increased separation efficiency. For example, an electrostatic precipitation system is known in which particles are electrically charged so that they are attracted to a counter-polarized surface and subsequently separated. In passive separators, no additional energy is introduced into the system. For example, passive separators use the kinetic energy of the gas stream. In this case, the particles are passed through a labyrinth or cyclone, for example, and can thus be separated from the gas stream due to the inertia of the particles, allowing the particles to be removed from the gas stream, which is cleaned up afterwards. In the case of oil separators in particular, the oil particles are returned to the oil circuit and the cleaned gas stream is returned to the intake air of the motor vehicle engine.

WO 2016/184768 describes a device for separating particles from a gas stream. The gas stream flows against the separator at an underside, which defines a flow inlet. The flow inlet opens into a flow channel, which is defined by a flow guide element forming the underside of the separator and a valve member movable relative to the flow guide element and projecting into the flow inlet. The flow directing element and the valve member are thereby dimensioned and arranged with respect to each other in such a way that the gas stream is deflected as it passes through the flow channel in order to increase the separation efficiency, that is, the efficiency of the separator. However, the oil separator described therein is reaching its limits due to the tightening of legal and environmental regulations and requirements with regard to the separation rate and the associated efficiency of the separator.

DE 20 2010 001 191 U1 describes an oil separation device in which a fleece is used for oil separation. The valve member is designed as a flat valve disc with through-holes to allow leakage flow in the closed valve member state. According to DE 20 2010 001 191 U1, the fleece is either arranged in the valve chamber in such a way that it is exposed to the leakage flow or is subjected to a substantially tangential flow when the valve member is open. On the oil separation device according to DE 20 2010 001 191 U1, on the one hand the limited separation effect of the fleece has proved to be a disadvantage. On the other hand, the fleeces tend to soot up and become clogged with particles, which increasingly reduces their separation efficiency and may require maintenance or replacement of the fleece.

Applicant’s publication, DE 10 2018 124 654 A1, discloses an oil separator having a spring-biased rotational valve member and a fleece fabric on a cover housing portion downstream of the valve member.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 is a sectional view of a particle separator, in a closed state, according to an exemplary embodiment of the disclosure.

FIG. 2 is the particle separator of FIG. 1 in an open state, according to an exemplary embodiment of the disclosure.

FIG. 3 is the particle separator of FIG. 1 and FIG. 2, in a further opening state, according to an exemplary embodiment of the disclosure.

FIG. 4 is a side view of an actuator of a particle separator according to an exemplary embodiment of the disclosure.

FIG. 5 is a side view of the actuator of FIG. 4, facing the gas stream inlet of the particle separator, according to an exemplary embodiment of the disclosure.

FIG. 6 is a sectional view of the actuator of FIG. 4, according to an exemplary embodiment of the disclosure.

FIG. 7 is a sectional view of a housing part forming a valve seat according to an exemplary embodiment of the disclosure.

FIG. 8 is a perspective view of a housing part forming a valve seat of a particle separator, according to an exemplary embodiment of the disclosure.

FIG. 9 is a sectional view of a particle separation system with two particle separators according to the disclosure, of which the left particle separator is shown in an open state and the right separator in a closed state, according to an exemplary embodiment of the disclosure.

FIG. 10 is a crankcase ventilation system, according to an exemplary embodiment of the disclosure, showing the generation of blow-by gases and the installation position of particle separators, and particle separation systems according to the disclosure.

FIG. 11 is a circuit diagram of a fuel cell system, according to an exemplary embodiment of the disclosure, integrated into a drive of a motor vehicle to show example installation position of particle separators and particle separation systems.

The exemplary embodiments of the present disclosure will be described with reference to the accompanying drawings. Elements, features and components that are identical, functionally identical and have the same effect are – insofar as is not stated otherwise –respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, and components have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

An object of the present disclosure to improve the disadvantages of the known prior art, including to provide a particle separator for cleaning a particle-laden gas stream, a particle separation system with two particle separators, a method for cleaning a particle-laden gas stream with the particle separator or the particle separation system, a fuel cell system and a crankcase ventilation system with an improved separation rate, which is in particular also improved at larger volume flows. The inventors of the present disclosure have found that there is further potential with respect to separation efficiency. In particular, it has been found that increased volumetric flows (e.g. of more than 30 l/min, and in particular of more than 70 l/min) advantageously provide an improved separation rate. In particular, since the fleece of the cover housing part is more or less bypassed. Furthermore, this advantageously reduces or avoids an increase sooting of the fleece.

Accordingly, in accordance with one aspect of the disclosure, a particle separator is provided for cleaning a gas stream laden with particles, such as fluid particles. In particular, the particle separator may be an oil separator or water separator. The particle separator may be suitable for separating oil particles and/or water particles. In particular, the gas stream can be a water-loaded gas stream, in particular an anode stream of a fuel cell, or a gas stream loaded with oil particles, in particular a blow-by gas stream.

In an exemplary embodiment, the particle separator may include a gas stream inlet at which the gas stream enters the particle separator with an inflow direction. In particular, the gas stream inlet may be formed in an inflow housing part of the particle separator. An inflow housing part means, in particular, that part of the housing of a particle separator against which the gas stream flowing towards the particle separator flows. The gas stream inlet may be designed in particular as a through-opening in the inflow housing part.

The particle separator further comprises a gas stream outlet at which the gas stream leaves the particle separator. In particular, the gas stream outlet may be formed as an exit opening in the housing of the particle separator. In particular, the gas stream exit may be formed between an inflow housing portion and a cover housing portion of the particle separator. In particular, the gas stream outlet may be arranged downstream of the valve member, valve seat and/or textile described below. In particular, the gas stream inlet and the gas stream outlet are arranged relative to each other such that the gas stream leaves the gas stream outlet in an outflow direction which may be inclined relative to the inflow direction by at least 30°, 40°, 50°, 60°, 70° or 80°, in particular by 90°.

The particle separator comprises a closed state in which, except for a leakage flow, a gas stream from the gas inlet to the gas outlet is prevented. A leakage flow refers to a volume flow of at least 1 l/min, 3 l/min, 5 l/min, 7 l/min, 10 l/min or 12 l/min and/or at most 15 l/min, 20 l/min, 25 l/min, 30 l/min, 35 l/min or 40 l/min. In particular, the leakage flow may have multiple leakage partial gas streams. In particular, the multiple leakage partial gas streams can be deflected to different degrees in the particle separator.

Furthermore, the particle separator comprises at least one opening state in which, in addition to the local flow, a large volume flow from the gas stream inlet to the gas stream outlet is permitted. A large volume flow means in particular a volume flow of more than 20 l/min, 30 l/min, 40 l/min, 50 l/min, 60 l/min, 80 l/min or 100 l/min.

In particular, the particle separator has a valve member and a valve seat. In particular, the valve member may be in radial and/or axial stop contact with the valve seat in the closed state. In the closed state, the leakage flow may be permitted in particular by contouring the valve seat and/or the valve member in the region of the axial and/or radial stop contact. In particular, the radial and/or axial stop contact of the valve seat can provide a flat contact surface for this purpose, while the corresponding contact surface of the valve member has a contoured contact surface, in particular one provided with depressions or recesses. Alternatively, the contoured contact surface can be formed on the valve seat and the flat contact surface on the valve member.

Alternatively, or additionally, the leakage flow can be enabled by passage openings in the valve member and/or in the valve seat.

The particle separator further comprises a deflection guide channel arranged between the gas stream inlet and the gas stream outlet, which deflects the large volume flow and/or the leakage flow by at least 90° with respect to the inflow direction. In particular, the deflection guide channel may be collar-shaped. In particular, the deflection guide channel may be formed between the valve seat and the valve member. In particular, the deflection guide channel may be bounded by the valve member in the inflow direction and by the valve seat in the direction opposite to the inflow direction. In particular, the valve member has a cup and a valve member collar adjoining the cup. In particular, starting from a cup base, the valve member extends in the inflow direction along a cup skirt, which widens in particular in the radial direction, and, viewed in the inflow direction, merges at the end of the cup skirt into the valve member collar, which extends arcuately first outwardly in the radial direction and then extends in the direction opposite to the inflow direction. In particular, the cup and the valve member collar delimit an annular space.

In particular, the valve seat may be configured complementary to the valve member. In particular, the valve seat has a hollow body which widens in the inflow direction and merges into a valve seat collar which extends arcuately first in the radial direction and then in the direction opposite to the inflow direction. In particular, at the end of the hollow body opposite the inflow direction, the gas stream inlet may be formed as a particularly circular inlet opening. In particular, the valve member may be telescopically displaceable into the hollow body. In particular, the valve member may be adjustable in the actuating direction and in the closing direction. In particular, the actuating direction corresponds to the inflow direction. In particular, the closing direction corresponds to the direction opposite to the inflow direction.

In one embodiment, the valve member may be in stop contact with the valve seat via the valve member collar in the closed state. By shifting the valve member from the closed state to the at least one open state, the large-volume flow can be released, which may be then deflected by at least 90° with respect to the inflow direction via the valve seat collar. Alternatively, or additionally, the stop contact surface of the valve seat collar and/or the area of the valve seat in stop contact with the valve seat collar can be contoured to allow a leakage flow in the closed state, which may be deflected by at least 90° with respect to the inflow direction. For this purpose, for example, the contouring at the end of the valve member collar can be formed in the closing direction.

In accordance with this aspect of the disclosure, the particle separator comprises a textile, in particular fleece, arranged such that at least a portion of the deflected large volume flow and/or the deflected leakage flow impinges on the textile.

In an exemplary embodiment, the textile may be formed from a flat textile structure, such as a fleece, a woven fabric, a knitted fabric, a braided fabric and/or felt. In an exemplary embodiment, the textile may be formed at least in part from a fleece fabric. A fleece may be generally a structure of fibers of limited length, continuous fibers (filaments) or chopped yarns, which have been joined and/or bonded together in any manner, in particular to form a fiber layer or a fiber pile.

Fleeces or nonwovens with a basis weight in the range of 100 g/m² - 400 g/m² , in particular in the range of 150 g/m² - 350 g/m² , in particular in the range of 200 g/m² -300 g/m², in particular in the range of 220 g/m² - 280 g/m² , preferably in the range of 230 g/m² - 270 g/m², have proved advantageous with regard to the separation rate of particles of the gas stream. A permeability to air, in particular a so-called air permeability, of the fleeces or fleece fabrics used may be in particular in the range of 975 l/(m²/s) - 2800 l/(m²/s), preferably in the range of 1100 l/(m²/s) - 2500 l/(m²/s), preferably in the range of 1200 l/(m²/s) - 2000 l/(m²/s), preferably in the range of 1300 l/(m²/s) - 1800 l/(m²/s), in particular at about 1800 l/(m²/s). In particular, the air permeability can be calculated according to DIN EN ISO 9237. Furthermore, a fiber thickness of the fibers forming the fleeces can be in the range of 0.02 mm - 0.03 mm, in particular about 0.025 mm.

As a further example, also fleeces or fleeces with a basis weight in the range of 300 g/m² - 650 g/m² , in particular in the range of 350 g/m² - 600 g/m² , in particular in the range of 400 g/m² - 550 g/m² , in particular in the range of 425 g/m² - 525 g/m² , in particular in the range of 450 g/m² - 500 g/m² , in particular in the range of 470 g/m -480 g/m²² , preferably about 475 g/m², can be used. The fiber geometry can be, for example, 5D x 51 mm. The strength in the longitudinal extension direction and/or transverse extension direction may be greater than 800 N/5 cm, in particular in the range of 800 N/5 cm - 1,600 N/5 cm, especially in the range of 900 N/5 cm - 1,400 N/5 cm, in particular in the range of 1,000 N/5 cm - 1,300 N/5 cm, especially in the range of 1,050 N/5 cm - 1,250 N/5 cm, in particular in the range of 1,100 N/5 cm - 1,200 N/5 cm, preferably about 1150 N/5 cm. The tensile elongation in the longitudinal extension direction and/or transverse extension direction can be in the range 40%- 140%, in particular in the range 50% - 120%, in particular in the range 60% - 100%, in particular in the range 70% - 90%, preferably about 80%. The tensile strength in the longitudinal extension direction can preferably be greater than 300 N, in particular in the range 300 N - 500 N, in particular in the range 320 N - 400 N, in particular in the range 340 N -370%, preferably at about 350 N. The tensile strength in the transverse stretching direction can preferably be greater than 300 N, in particular in the range 300 N - 600 N, in particular in the range 350 N - 500 N, in particular in the range 400 N - 450%, preferably at about 420 N.

According to advantageous embodiments of fleeces, a thickness considered transversely to the planar extension of the fleeces, in particular a layer thickness, can be in the range of 1.5 mm - 5 mm, preferably in the range of 1.7 mm - 4 mm, preferably in the range of 1.9 mm - 3 mm, in particular at about 2 mm.

According to an advantageous embodiment, the textile, in particular the fleece, comprises a polyester material, in particular thermoplastic polymer, such as PET or PTFE.

In particular, the textile may be arranged on the inflow housing part of the particle separator. In particular, the textile may be arranged within the housing of the particle separator. In particular, the textile may be arranged within the housing of the particle separator at the inflow housing part. In particular, the textile may be arranged on the inflow housing part such that the inflowable surface of the textile may be aligned with the housing cover part. In particular, the textile may be arranged downstream of the deflection guide channel. In particular, the textile may be arranged such that the large volume flow and/or the leakage flow, after being deflected by at least 90°, flows towards the textile through the deflection guide channel. In particular, the textile may be arranged in such a way that the deflection guide channel deflects the large-volume flow and/or the leakage flow in the direction of the textile with respect to the inflow direction. In particular, the leakage flow may be deflected by the deflection guide channel in such a way that it strikes the textile essentially in the direction opposite to the inflow direction.

In particular, the textile may be annular in shape. In particular, the textile may be inserted into an annular receptacle of the inflow housing part. In particular, the textile extends circumferentially around the valve seat and/or the valve member. In particular, the valve member and the valve seat are arranged radially within the textile. In particular, the textile may be arranged downstream of the valve seat and/or the valve member and upstream of the gas stream outlet.

The at least one opening state described above can in particular be understood to mean a partially opened state in which the valve member may be free from axial and/or radial abutment contact with the valve seat, the inflow housing part and/or the cover housing part. In this state, for example, a large-volume flow can be deflected onto the textile via the deflection guide channel and, at the same time, a leakage flow can be permitted, for example via through-openings in the valve member, which is not deflected at all or at least to a lesser extent than the large-volume flow. For this purpose, openings, in particular bores, can be formed in the valve member and/or valve seat, for example. In one embodiment, passage openings, in particular four circumferentially distributed passage openings, are provided for this purpose in the valve member collar, in particular at the transition between the cup and the valve member collar.

In one embodiment, a second textile, in particular fleece, may be attached to the housing cover portion of the particle separator. In particular, the second textile may be a fleece. In particular, the second textile may be annular in shape. In particular, a leakage flow, in particular a partial leakage flow, flows directly against the second textile via the previously described passage openings both in the closed state and in the open state.

In addition to the at least one opening state described above, which can also be referred to as a partially opened state, the particle separator can also have a fully opened state. In this state, the valve member in particular has a stop contact with the housing cover part. In the fully open state, in particular, the deflection guide channel may be wider than in the partially open state, so that a larger large volume flow, in particular of up to 120 l/min, is permitted. In the fully open state, the leakage flow, which is permitted, for example, in the partially open state through passage openings in the valve member collar, can be prevented by sealingly closing the passage openings in the stop contact. In one embodiment, the stop contact in the fully open position can be implemented by contact of the valve member collar with the second textile. For this purpose, the valve seat collar can have an annular stop at its end in the inflow direction, which may be in stop contact with the second textile in the fully closed state. The annular stop can be penetrated by the at least one passage openings described above.

According to one embodiment, the deflection guide channel deflects the large-volume flow and/or the leakage flow by at least 100°, 110°, 120°, 130° or at least 140°, in particular by essentially 180°, with respect to the inflow direction. A deflection of essentially 180° is to be understood in particular as a deflection between 150° and 210°, 155° and 205°, 160° and 200°, 165° and 195°, 170° and 190° or 175° and 185°. A deflection of essentially 180° can be realized in particular by using a valve member with cup and valve member collar. In an exemplary embodiment, the deflection guide channel may be collar-shaped for this purpose. In particular, the collar-shaped deflection guide channel may be bounded by the valve member collar in the actuating direction and by the valve seat collar in the closing direction.

In one embodiment, the particle separator may be in the closed state at a volume of 30 l/min of the gas stream to be cleaned. This can be realized in particular by using a valve member that is biased into the closed state. For this purpose, a spring, in particular a spiral spring, can be provided between the valve member and the cover housing part of the particle separator. In particular, the valve member may be biased in the closed state in such a way that a volumetric flow of up to 30 l/min can flow through the particle separator as a leakage flow, for example via the previously described contouring and/or at least one passage opening, without setting the valve member in at least one of the open states. In particular, the aforementioned contouring and/or passage openings are adapted to the preload of the valve member in such a way that the flow resistance increases at a volume flow of more than 30 l/min in such a way that the volume flow moves the valve member into the at least one opening state against the preload force.

In particular, at a volume flow of more than 30 l/min and in particular a maximum of 70 l/min, the valve member may be in a partially open state in which the large volume flow may be diverted via the deflection guide channel to the textile, in particular the textile arranged on the inflow housing part. At the same time, in this partially open state, a leakage flow can still be diverted, for example via the previously described passage openings, to a second textile, in particular a textile arranged on the cover housing part.

Particularly at volume flows of more than 70 l/min and especially up to 120 l/min, the valve member may be displaced in the actuating direction to such an extent that it comes into particularly axial abutment contact with the housing cover part or the second web. In this way, the leakage flow in particular can be prevented, so that the entire flow may be directed as a large-volume flow via the deflection guide channel onto the first textile.

The inventors of the present disclosure have found that flowing a textile with a deflected gas stream causes a surprising increase in the degree of separation compared to flowing a textile with an undeflected gas stream. Therefore, it has turned out to be particularly preferred to first deflect both the leakage flow in the closed state and the large-volume flow in the at least one open state by at least 90° before flowing onto the textile. The aforementioned deflection by essentially 180° has proven to be particularly advantageous.

Another aspect of the present disclosure, which may be combinable with the previously described aspect and embodiments thereof, also relates to a particle separator for cleaning a gas stream loaded with particles, such as fluid particles. The particle separator comprises a gas stream inlet where the gas stream enters the particle separator, a gas stream outlet where the gas stream exits the particle separator, and a conduit arranged between the gas stream inlet and the gas stream outlet. In accordance with this aspect of the disclosure, a textile may be disposed in the conduit and may be provided with a coating that reduces adhesion of particles to the textile. In particular, the coating may be hydrophobic and/or oil repellent.

The textile may be arranged as the textile according to the previously described aspect of the disclosure. Further, the textile may be formed in material and shape as previously described. In particular, the conduit channel comprises the entire space traversed by the gas stream between the gas stream inlet and the gas stream outlet. In particular, the conduit channel comprises the entire separator space bounded between an inflow housing portion and a cover housing portion of the particle separator. In particular, the textile may be arranged in the conduit channel such that it is flowed against by the gas stream. In particular, this aspect of the disclosure includes particle separators with and without movable valve members. In an embodiment with movable valve member and valve seat, the textile may be arranged in a section of the conduit channel downstream of the valve member and the valve seat. In embodiments where the conduit includes a deflection guide channel, the coated textile may be disposed downstream of the deflection guide channel. In an exemplary embodiment, in accordance with the previously described aspect of the disclosure, the coated textile may be arranged to be impinged upon by a deflected large volume flow and/or leakage flow. In an exemplary embodiment, a coated textile according to this aspect of the disclosure may be arranged on the inflow housing portion of the particle separator and/or a coated textile according to this aspect of the disclosure may be arranged on a cover housing portion of the particle separator.

The inventors of the present disclosure have found that by applying the coating reducing the adhesion of particles, the clogging of the textile can be slowed down, in particular avoided. This clogging is also referred to as sooting. By avoiding the clogging, both the lifetime and the separation rate of the particle separator can be improved. In particular, when using the particle separator as an oil separator, it has been found that coarse particles, such as soot, lead to rapid clogging of the textile and thus reduce the separation rate. Surprisingly, this could be prevented with the measure according to the disclosure. The inventors have also found that the problem of clogging is particularly prevalent in particle separators with moving valve members, and particularly severe in spring-biased valve members. Surprisingly, especially in these embodiments, the problem of clogging/sooting could be solved by the coating of the textile according to the disclosure. Therefore, this aspect of the disclosure relates more particularly to a spring-biased particle separator, in particular an oil separator, comprising a valve member and the textile layer coated according to the disclosure. In particular, it has been found that with the measure according to the disclosure, clogging/sooting is prevented through the removal of coarse particles are removed involuntarily due to the smooth surface and the lack of cohesion at higher volume flows. Thus, this aspect of the disclosure provides a self-cleaning function of the textiles. Furthermore, the coating of the textile particular has an oil repellent effect.

In one embodiment, the coating may be applied by spraying or coating, preferably printing, by impregnating the textile, steaming or lacquering. Alternatively, or additionally, the coating may be a silane-based solution, for example a liquid or powder coating material, in particular a lacquer, such as a silicon lacquer. In one embodiment, the coating, in particular the silicon varnish coating, may be applied during blowing of the fleece fibers, so that in particular each fiber of the fleece may be provided with the coating.

In one embodiment of this or the previously described aspect of the disclosure, the textile comprises a polyester material, particularly a thermoplastic, such as polyethylene terephthalate (PET) or Polytetrafluoroethylene (PTFE). In an exemplary embodiment, the textile may be a PFTE fleece.

Advantageously, the coated fleece may be used in both the previously described aspect of the present disclosure and the subsequently described aspect of the present disclosure. In an exemplary embodiment, two fleeces coated according to the disclosure are used, one of which may be arranged on an inflow housing part and another of which may be arranged on a lid housing part of the particle separator. In an exemplary embodiment, the fleece on the cover housing part and/or on the inflow housing part may be flowed against in the closed state via a leakage flow.

Another aspect of the present disclosure, which may be combinable with the previously described aspects and embodiments thereof, also relates to a particle separator for cleaning a gas stream laden with particles, such as fluid particles. The particle separator comprises a gas stream inlet, where the gas stream enters the particle separator with an inflow direction. Further, the particle separator comprises a gas stream outlet where the gas stream exits the particle separator. Furthermore, the particle separator comprises a gas stream divider designed to divide the gas stream into at least two partial gas streams, in particular into a leakage flow and a large volume flow, as well as a deflection guide structure arranged downstream of the gas stream divider, which deflects one partial gas stream more strongly than at least one further partial gas stream. Furthermore, the particle separator comprises a textile, in particular fleece, arranged such that at least a portion of the more strongly deflected gas stream impinges on the textile, and a further textile, in particular fleece, arranged such that at least a portion of the less strongly deflected gas stream impinges on the further textile. In an exemplary embodiment, the gas stream inlet, the gas stream outlet and/or the textile are designed as described above in their dimensioning, material selection and positioning.

The particle separator according to this aspect of the disclosure may be a static particle separator or a particle separator having a closed state and at least one open state as previously described. In particular, the gas stream divider may be configured to divide the gas stream into two partial leakage flows in a closed state. In this case, the deflection guide structure can be designed to deflect the two partial leakage flows to different extents in the closed state. Alternatively, or additionally, the gas stream divider may be configured to divide the gas stream in an open state, in particular in a partially open state, into at least one leakage flow and one large volume flow. Furthermore, the gas stream divider can be designed to divide the gas stream into at least two partial flows only in certain states, in particular in the closed and/or partially opened state. For example, the gas stream divider can be designed not to subdivide the gas stream in a fully open state.

The deflection guide structure can be designed to deflect one partial gas stream and deflect the other partial gas stream less or not at all. In particular, the deflection guide structure can be designed to allow one partial gas stream to pass essentially without deflection and to deflect the other at least one partial gas stream. By substantially deflection-free is meant in particular a deflection of less than 45°, 30°, 15°, 10° or 5° relative to the inflow direction.

In one embodiment, the gas stream divider and the baffle structure may be formed by a valve member and a valve seat of the particle separator. In particular, the gas stream divider and the baffle structure may be implemented by the exemplary embodiment of the valve member and the valve seat described previously and below. In particular, the gas stream divider may be implemented by at least one passage opening formed in the valve member. In particular, the at least one passage opening realizing the gas stream divider may be formed at the transition between the cup and the valve member collars of the valve member. As a result, a portion of the gas stream that has substantially not been diverted over the cup can be divided via the at least one passage opening from the remaining gas stream, which may be subsequently diverted over the valve member collar.

In particular, the deflection guide structure can be formed by the valve member collar, which deflects the remaining gas stream with respect to the inflow direction. At the downstream end of the valve collar, contouring can be provided as described above so that the more strongly deflected partial gas stream can also exit the particle separator as a partial leakage flow in the closed state of the particle separator.

In an exemplary embodiment, the downstream end of the valve member collar may be in sealing contact with the valve seat in the closed state so that no splitting of the gas stream occurs in this condition. In this embodiment, splitting only occurs when the valve member is moved from a closed position to an open position.

In an exemplary embodiment, the two textiles according to this aspect of the disclosure are arranged such that the two partial gas streams flow substantially directly towards them. In this context, substantially direct flow means in particular that the partial gas streams flow towards the respective textile immediately after leaving the gas stream divider and/or the deflection guide structure.

In one embodiment, the deflection guide structure deflects the more strongly deflected gas stream by at least 90°, in particular by at least 100°, 110°, 120°, 130° or at least 140°, in particular by essentially 180° with respect to the inflow direction. Alternatively, or additionally, the less strongly deflected partial gas stream may be deflected by less than 60°, 45°, 30°, 15° or 5°. In particular, the less strongly deflected partial gas stream passes through a flow channel between the valve member and the valve seat, especially in the closed or partially opened state, and leaves this channel through at least one passage openings in the valve member, via which the less strongly deflected partial gas stream meets the further textile directly. Alternatively, or additionally, the gas stream divider and the deflection guide structure are designed in such a way that the more strongly deflected gas stream flows through a gap, in particular a collar-shaped gap, between the valve seat and the valve member and flows at the downstream end of the valve seat and/or valve member onto the textile associated with the more strongly deflected gas stream. In an exemplary embodiment, the gas stream divider and the deflection guide structure are designed in such a way that the less strongly deflected partial gas stream flows through the passage openings onto the further textile at least in the closed state and/or in the partially opened state and/or the more strongly deflected partial gas stream flows via the downstream end of the valve member and/or valve seat onto the textile associated with the more strongly deflected partial gas stream at least in the closed state, in the partially opened state and/or in the fully opened state.

According to exemplary embodiments of the aspects of the disclosure described above, the deflection guide channel, the conduit channel, the gas stream divider and/or the deflection guide structure may be formed, at least in sections, by a movable valve member for adjusting the volume flow passing through the particle separator. In particular, the valve member may be preloaded into the closed state, in particular spring-biased.

As described above, the particle separator may include a valve seat defining the gas stream inlet and a valve member. The valve member may be displaceable in particular between a closed position, in which the valve member may be brought into stop contact with the valve seat, and at least one open position, in which the valve member may be moved out of the stop contact in an axial actuating direction. The stop contact has in particular an axial stop contact and a radial stop contact.

The radial stop contact may be formed in particular by a radial stop contact surface of the valve member, in particular the cup, and a radial stop contact surface of the valve seat, in particular the hollow body. For this purpose, the valve seat, in particular hollow body, has at least one radial projection on its inner side. In particular, the radial stop contact surface of the hollow body may be formed by the surface facing the cup closing state. In particular, the radial abutment contact surface of the hollow body may be formed complementary to the radial abutment contact surface of the cup in order to form a planar radial abutment contact in the closed state. In particular, the hollow body can have a plurality of radial projections offset from one another in the circumferential direction to form the radial stop contact. In order to permit the previously described leakage flow in the closed state, the at least one radial projection may be, in particular, not formed as a projection that is continuous in the circumferential direction, so that at least one leakage flow channel is also formed between the cup and the hollow body in the closed state.

The axial stop contact may be formed in particular by an axial stop contact surface of the valve member, in particular the deflecting screen, and an axial stop contact surface of the inflow housing part, in particular the valve seat. For this purpose, a stop flange may be formed on the inflow housing part. The surface of the stop flange facing the deflector screen or shield in the actuating direction forms the axial stop contact surface of the inflow housing part. The stop flange may adjoin the valve seat collar downstream and extend from the latter in the closing direction, where it merges into a radial web of the inflow housing part. The axial stop contact surface of the deflector shield may be formed by its side facing the stop flange in the closing direction. The deflector shield may be contoured with projections - to form the stop contact surface - and recesses - to ensure leakage flow in the closed state.

In particular, the valve member has a rotational cup facing the gas stream to be cleaned. In an exemplary embodiment, the valve member also has a rotationally shaped deflection screen adjoining the cup, which deflects the counterflow in the at least one open position in the direction of the textile, in particular the textile associated with the more strongly deflected partial gas stream. In particular, the deflection screen may be configured to deflect the gas stream by at least 90°, in particular by at least 100°, 110°, 120°, 130° or 140°, in particular by substantially 180°, with respect to the inflow direction. In particular, the deflection shield may be referred to as a valve collar and may be formed with one or more of the previously described valve collar features.

In one embodiment, the deflector shield extends axially against the axial direction of adjustment by less than 60%, in particular less than 55% or less than 50% of the axial dimension of the cup.

According to one embodiment, the particle separator comprises an inflow housing part having the valve seat and a textile receptacle, in particular a recess, for the textile. In particular, the textile receptacle may be formed as an annular recess in the inflow housing part. In particular, the valve seat described above, the valve member described above, and/or the stop flange described above extend radially within the textile receptacle, or are circled by it. In particular, the textile receptacle circumferentially circumvents the valve seat, the valve member and/or the stop flange. In particular, an annular textile, especially an annular fleece, may be inserted in the valve seat.

In one embodiment, the particle separator further has a cover housing part with a textile receptacle and opposite the inflow housing part, in particular a depression, for a further textile, in particular for the further textile described above. The further textile receptacle may be formed in particular as an annular recess in the cover housing part. In particular, the further textile receptacle circumferentially surrounds a guide pin of the valve member. In particular, the further textile receptacle and the further textile arranged therein are arranged opposite the at least one passage opening provided in the valve member, in particular in order to direct a leakage flow, partial leakage flow and/or less strongly deflected partial flow emerging from this at least one passage opening directly onto the further textile.

According to an exemplary embodiment of the aspect of the present disclosure described as the first aspect, the textile receptacle of the inflow housing part may be dimensioned and/or arranged such that both the leakage flow in the closed state and the large volume flow in the at least one open state flows in the direction of the textile receptacle. According to an embodiment of the aspect of the present disclosure described as the second aspect, the textile receptacle of the inflow housing portion may be dimensioned and/or arranged such that the gas stream flows in the direction of the textile receptacle. According to an embodiment of the aspect of the present disclosure described as third, the textile receptacle of the inflow housing part may be dimensioned and/or arranged such that one of the two partial streams flows in the direction of the textile receptacle.

According to one embodiment, the valve member may be movable and/or dimensioned such that it is free from abutting contact with the textile. This means in particular the textile associated with the inflow housing part. In particular, the valve member may be free from an engaging contact with the textile in the closed state. Embodiments in which the valve member may be in engaging contact with the further textile in the fully open state are in particular intended to be covered by this embodiment.

For this purpose, the inflow housing part can have a stop flange, in particular adjacent to the textile receptacle, with which the valve member can come into stop contact, in particular in the closed state. As described above and below, the valve member can have a contouring at its contact point with the stop flange in order to allow a leakage flow along the stop contact in the closed state. Alternatively, or additionally, the contouring may be formed on the stop flange. The inventors of the present disclosure have found that by avoiding a stop contact between the valve member and the textile, particularly in the closed state, adhesion, particularly freezing at cold temperatures, of the valve member with the textile can be prevented so that the textile is not torn loose from its anchorage when the valve member is moved to an open state. In particular, the stop flange can comprise plastic, in particular be made of plastic, especially for this purpose.

The disclosure further relates to a particle separation system comprising two of the previously described particle separators for cleaning a gas stream loaded with particles, such as fluid particles, wherein the particle separators are in fluid communication with each other.

According to one embodiment, the two particle separators are fluidly connected to each other in such a way that the gas stream to be cleaned can be divided into the at least two particle separators upstream of the particle separation system and/or a gas stream from one particle separator can pass into at least one further particle separator.

Further, the disclosure relates to a method of cleaning a gas stream laden with particles, such as soot particles, wherein the gas stream may be introduced into a particle separator according to any of the aspects of the disclosure previously described or a particle separation system according to any of the embodiments previously described.

According to one embodiment of the method, the particle separator remains in a closed state up to a gas stream of 30 l/min, in particular in the closed state described in connection with the aspect of the disclosure described as the first aspect. Alternatively, or in addition, in the method, at a gas stream of more than 30 l/min and at most 70 l/min, the particle separator may be placed in a partially open state, in particular in the at least one open state according to the aspect of the disclosure described as the first aspect. Alternatively, or additionally, the particle separator may be brought into a fully open state at a gas stream of more than 70 l/min.

According to one embodiment of the method, the particle separator may be displaced between the closed state and the at least one open state in dependence on the gas volume flow.

The method may be configured/executed to operate a particle separator and/or particle separation system according to any of the previously described aspects of the disclosure.

Furthermore, the disclosure relates to a fuel cell system for a motor vehicle, comprising a fuel cell and a particle separator arranged in a particle-carrying conduit system, which may be formed according to one or more of the previously described aspects of the disclosure. In particular, the conduit system carries a particle-laden gas stream. In particular, the particle carrying conduit system may be a hydrogen supply for the anode of the fuel cell. In particular, the particle separator may be fed by an anode exhaust gas stream from which the particle separator removes water and feeds it back to the anode via an ejector together with hydrogen, in particular to wet the anode with water.

Further, the disclosure relates to a fuel cell vehicle having the fuel cell system described above. In this regard, the fuel cell vehicle may comprise the fuel cell system described above and may further comprise a cooling system for the fuel cell, an oxygen supply for the cathode of the fuel cell, and/or an electrical system for storing electrical energy provided by the fuel cell and/or for converting the energy into a driving power of the fuel cell vehicle.

Further, the disclosure relates to a crankcase ventilation system for a motor vehicle comprising a crankcase having a flow outlet port for removing blow-by gases from the crankcase and a particle separator or particle separation system according to one or more of the previously described aspects of the disclosure fluidly communicating with the flow outlet port for cleaning the blow-by gas of oil particles.

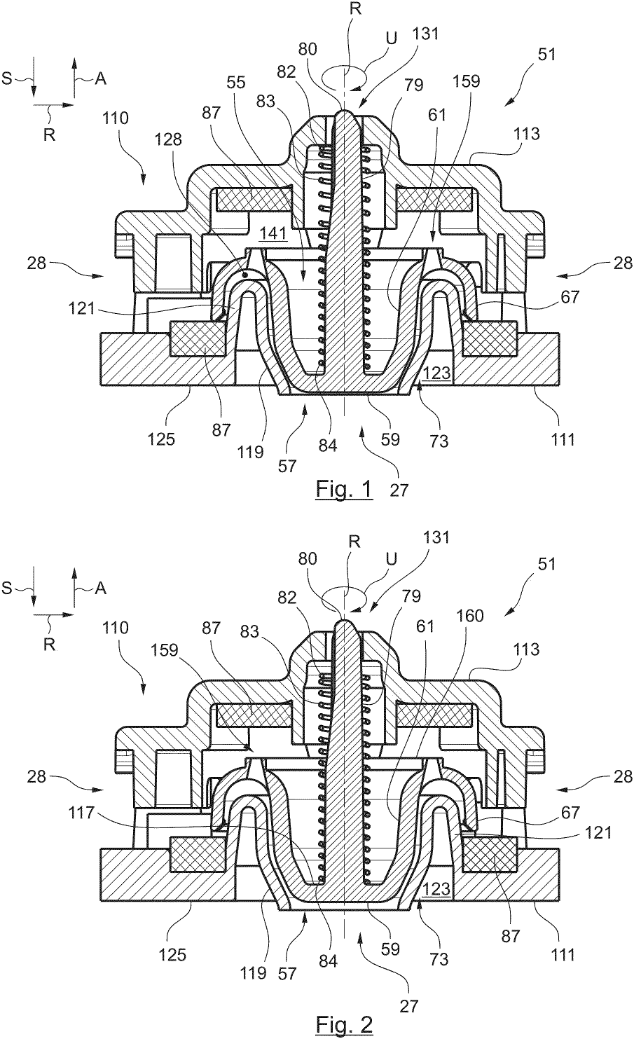

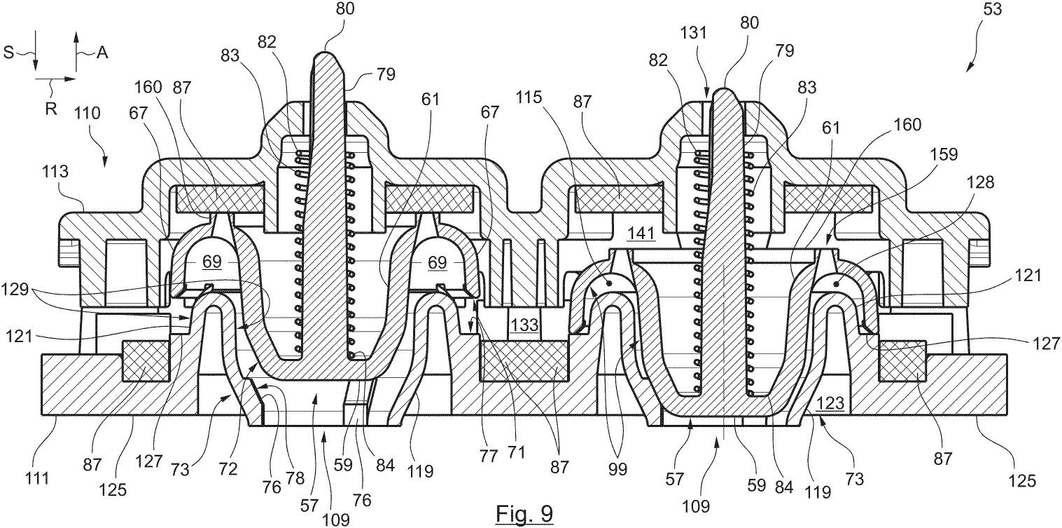

FIGS. 1 to 3 show an embodiment of a particle separator 51 in which the valve member 55 is in abutting contact with the textile 87 in the closed state. However, an exemplary embodiment of the disclosure is as shown in FIG. 9 in which the valve member 57 is free from abutting contact with the textile 87 in the closed state (shown on the right). For this purpose, a stop flange 127 is provided to realize a clearance between the valve member 55 and the textile 87 in the closed state. In the following, the operation of particle separators according to the disclosure will be briefly explained with reference to FIGS. 1 to 3, and then the detailed embodiment of the present disclosure will be described with reference to the remaining yfigures.

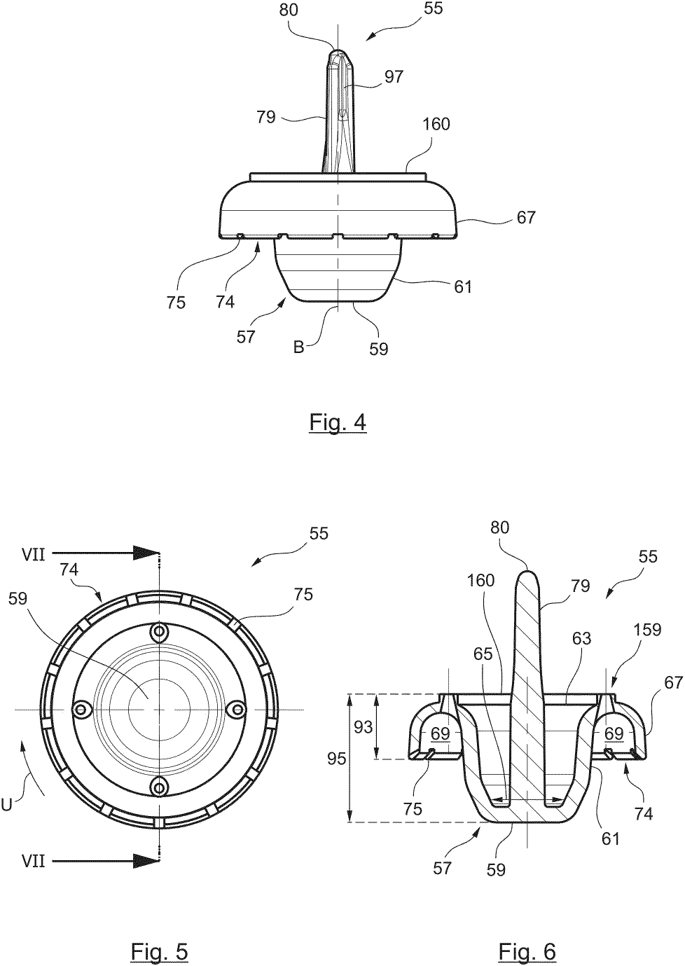

FIG. 1 shows the closed state of a particle separator 51 according to the disclosure, in which a leakage flow is allowed between the gas stream inlet 27 and the gas stream outlet 28. The leakage flow enters the particle separator 51 via the gas stream inlet 27, flows along a collar-shaped gap 128 between the valve seat 73 and the valve member 55, leaves the collar-shaped gap 128 in the form of a partial leakage flow via passage openings 159 and in the form of a second partial leakage flow via the contouring 74 with depressions 75 of the axial stop surface 71 of the valve collar 67, which can be taken from FIGS. 4 to 6. In this case, the collar-shaped gap 128 forms the deflection guide channel which deflects one of the partial leakage flows by 180° with respect to the inflow direction A. Herein, a textile 87 may be inserted into the inflow housing part 111 so that the partial leakage flow deflected by 180° impinges on the textile 87. A second textile 87 may be introduced in the cover housing part 113, so that the substantially undeflected partial leakage flow escaping via the passage opening 159 also impinges on a textile 87. Subsequently, the partial leakage streams exit the particle separator 51 via the gas stream outlet 28.

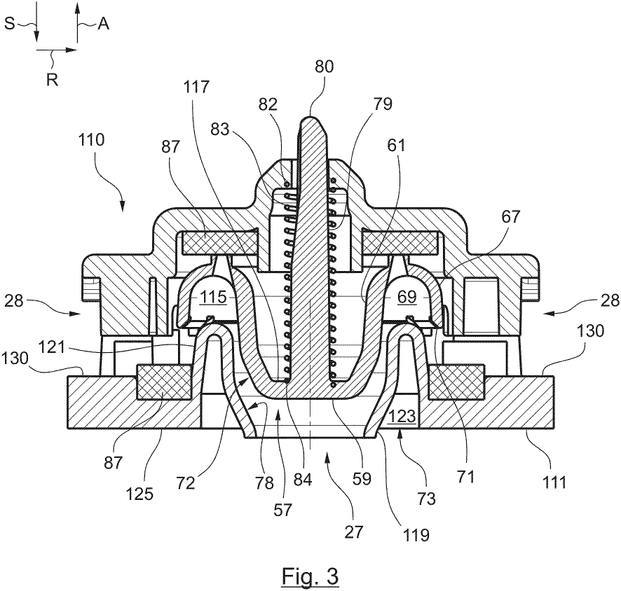

FIG. 2 shows a partially open state in which a leakage flow continues to be present via the passage openings 159, but in addition thereto a large volume flow impinges on the textile 87 downstream of the valve member collar 67. In this condition, a substantially undeflected leakage flow impinges on the further textile 87 disposed in the housing cover 113 via the passage openings 159, while a large volume flow deflected by substantially 180° impinges on the textile 87 disposed in the inlet housing portion. FIG. 3 shows a fully open state in which the valve member 55 may be in abutting contact with the textile 87 disposed in the housing cover portion 113, thereby substantially blocking the passage openings 159. In this state, the gas stream is substantially completely deflected 180° as a large volume flow and subsequently impinges on the textile 87 disposed in the inflow housing portion 125.

In accordance with the aspect of the disclosure described as the second aspect, the textile 87 disposed in the inflow housing portion 125 and/or the textile 87 disposed in the cover housing portion may be provided with the previously described coating that reduces adhesion of particles to the textile. The conduit described in connection with this aspect of the disclosure may include the entire separator chamber 115, which in turn may include the bypass chamber 141 and the collar-shaped gap 128.

With respect to the aspect of the disclosure described as a third aspect, the gas stream divider in FIGS. 1 to 3 is implemented by the passage openings 159 in the valve member 55. This divides the gas stream in FIG. 1 into a partial leakage flow that escapes via the passage openings 159 and a partial leakage flow that escapes via the contouring 74 of the valve member 55. The deflection guide channel (deflection guide structure) may be implemented here by the valve member collar 67, which deflects the partial leakage flow remaining in the collar-shaped gap 128 more than the partial leakage flow escaping via the passage opening 159, namely by about 180°. In FIG. 2, the splitting via the gas stream divider is similar to FIG. 1, but with the difference that in FIG. 2 the more strongly deflected gas stream is no longer a partial leakage flow, but the large volume flow. In FIG. 3, the passage openings 159 are substantially closed by the textile 87 disposed in the lid housing portion 113, so that in the fully open state, there is substantially no splitting via the gas stream divider.

FIGS. 4 to 6 show an exemplary embodiment of a valve member 55 for a particle separator 51 according to the disclosure in side view (FIG. 4), bottom view (FIG. 5) and sectional view along section line VII-VII (FIG. 6). The valve member 55 comprises a cup 57 with a cup base 59 extending substantially in the radial direction R, in particular in the form of a disk. A jacket 61 extends from the cup base 59 substantially in the actuating direction A. The jacket or shell 61 and the cup base 59 form a cup 57 which is open towards one side 58 in the actuating direction A. In a closing direction S oriented in the opposite direction to the actuating direction A, the jacket 61 tapers and opens into the disk-shaped cup base 59. In an exemplary embodiment, the cup base 59 and the jacket 61 are rotationally shaped, the taper of the jacket 61 may be limited such that the maximum inner diameter 63 of the jacket 61 may be at most 30%, 50%, 70% or 110% larger than the minimum inner diameter 65 of the jacket 61.

A valve member collar 67, which can also be referred to as a deflecting shield 67, adjoins or opens into the jacket 61, in particular at the end of the jacket 61 pointing in the actuating direction A. The valve member collar 67 may be of a rotational design and extend, in particular arcuately, starting from the jacket 61 initially substantially in radial direction R and subsequently substantially in closing direction S. The valve member collar 67 and the cup 57, in particular the jacket 61, delimit an annular space 69 of the valve member 55, which is open in closing direction S. The valve member collar 67 may be designed in such a way that it can be rotated in the closing direction.

In an exemplary embodiment, an end of the collar 67 facing in the closing direction S forms a substantially circumferential axial stop contact surface 71 of the valve member 57 for the stop contact between the valve member 57 and the valve seat 73. A stop contact between the valve member 55 and the valve seat 73 can be seen from the particle separator 31 shown on the right in FIG. 9. A circumferential direction is indicated in the following by the reference sign U.

As can be seen in FIGS. 4 to 6, the stop contact surface 71 of the valve member 57 and/or a stop contact surface 77 of the valve seat 73 may be contoured to allow leakage flow in the closed position, that is, in the stop contact, of the particle separator 51. The contouring, generally indicated by the reference numeral 74, of the at least one stop contact surface 71 may have at least one projection and/or at least one depression 75. The contouring 74 has the effect, for example, that in the closed position there may be a gap (not shown) extending at least in sections in the circumferential direction U between the valve member 55 and the valve seat 73. A gap extension in the circumferential direction U and/or a gap dimension in the axial direction can thereby be dimensioned as a function of a predefined leakage flow to be set, which is to be permitted in the closed position. In the embodiments shown, the contouring comprises a plurality of recesses 75 (recesses) on the stop contact surface 71 of the valve member collar 67. The plurality of recesses 75 are distributed circumferentially, in particular at equidistant distances from one another, on the contouring 74, in particular on the valve seat collar 67. In the present embodiment, the contouring 74 comprises thirteen recesses 75, but more or fewer recesses 75 may be provided. In the examples shown, the recesses 75 are shown as having an exemplary rectangular cross-section. However, they may have other cross-sectional shapes, such as that of a circle, an ellipse, a triangle, a pentagon, etc. It has been found advantageous to incline the recesses 75 downstream in the closing direction S, starting from a plane extending in the radial direction R, in order to direct the passage which occurs via the contouring towards the stop contact surface 77 of the valve seat 73, whereby the degree of separation, that is, the efficiency of the separation device 51, can be increased.

Passage openings 159 are provided in the valve member 55 for allowing leakage flow in the closed position. These passage openings 159 can be provided in addition to or as an alternative to the previously described contouring 74. In the example shown here, the passage openings 159 are formed as four bores which are introduced into the valve member 55 at equidistant intervals in the circumferential direction. These extend through the valve member 55 in the actuating direction A. In the present case, the through-holes 159 are formed in the part of the valve collar 67 directly adjoining the jacket 61 in the radial direction R. The through-holes 159 are formed in the valve collar 67. In this way, it can be ensured in particular that partial flows of the leakage flow exiting through the passage openings 159 are deflected by the valve member to a lesser extent than partial flows of the leakage flow exiting via the contouring 74.

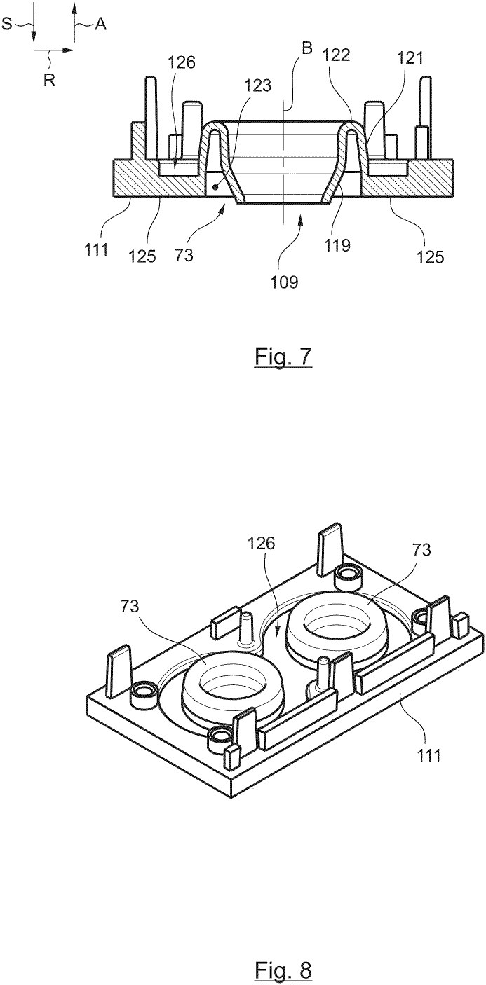

In FIG. 7, the inlet housing part 125 is shown without the cover housing part 113, without the valve member 55 and without the textile 87. As can be seen in FIG. 7, the textile receptacle 126 may be essentially formed as an annular gap.

FIG. 8 shows an exemplary inflow housing part 125 in perspective view, from which it can be seen that the textile receptacles 126 are designed in particular as annular gaps. As can be seen from FIG. 8, both particle separation systems with, for example, two particle separators can merge into one another so that textiles inserted into them, in particular annular textiles, can contact one another.

FIG. 9 shows an exemplary embodiment of a particle separation system according to the disclosure, which includes two particle separators 51 according to the disclosure which are in fluid communication with each other, the left particle separator 51 being shown in the fully open state and the right particle separator 51 being shown in the closed state. The valve members 55 of the separator devices 51 shown in FIG. 9 substantially correspond to the valve member shown in FIGS. 4 to 6.

The particle separators 51 of the particle separation system 53 are arranged parallel to each other and are in fluid communication with each other. By arranged parallel to each other it is meant that the particle separators 51 are arranged in such a way that a gas stream impinging on the particle separation system 53 can enter both particle separators 51 simultaneously, or can split into the two particle separators 51. Each particle separator 51 has a gas stream inlet 27 via which a gas stream impinging on the particle separation system 53 can be split into both particle separators 51. Even though FIG. 9 only shows the coupling of two particle separators 51 in the form of a particle separation system 53, it should be clear that the preceding and following description of the particle separators 51 applies both to a particle separation system 53 with two particle separators 51 as well as to a particle separation system 53 with more than two particle separators 51 arranged parallel to one another.

The particle separator 51 comprises a housing 110, in particular a two-part housing. The housing 110 comprises an inflow housing part 111 and a cover housing part 113 connectable or connected thereto. The inflow housing part 111 and the cover housing part 113 can be detachably connected to each other, in particular via a clip connection (not shown). In particular, the inflow housing portion 111 may be connected to a crankcase via a tongue and groove connection (not shown). In an exemplary embodiment, the inflow housing portion 111 may be connected to a crankcase via a tongue-and-groove connection. The particle separator 51 includes a valve seat 73 defining the gas stream inlet 27. The valve seat 73 may be part of the housing 110, in particular part of the inflow housing part 111. In an exemplary embodiment, the valve seat 73 and the inflow housing part 111 are made of one piece. In the illustrated particle separation system 53, the valve seats 73 of the two particle separators 51 and the inflow housing parts 111 are made of one piece. The cover housing parts 113 of the two particle separators 51 are also made in one piece. For example, injection molding processes are used.

The housing 110 defines a separation chamber 115 for separating particles from the gas stream and for supporting and guiding the valve member 55. The valve member 55 may be mounted in the separation chamber 115. In the closed state, the valve member 55 may be in abutting contact with the valve seat 73. In the abutting contact, the radial and axial stop contact surfaces 71, 72 of the valve member 55 and the radial and axial stop contact surfaces 77, 78 of the valve seat 73 are in contact with each other. In the process, the valve member 55 may be pressed against the valve seat 73 by a spring 83, which may be designed, for example, as a helical spring and may be supported on the valve member 55 by an axial end 84. With an axial end 82 opposite to the axial end 84, the spring 83 may be supported on the cover housing part 113. If a gas stream with sufficient pressure acts against the valve member 55, the latter may be moved in actuating direction A from the closed state to an open state. In the process, the gas stream acts against the spring force of the spring 83, whereby, for example, a multi-spring arrangement, such as a series connection of at least two springs 83, can also be provided. When the valve member 55 may be displaced in the actuating direction A, the spring 83, which may be supported between the valve member 55 and the cover housing part 113, is compressed. With increasing displacement of the valve member 55 in the actuating direction A, the spring force acting against the displacement movements of the valve member 55 increases. By using springs with a progressively wound spring characteristic and/or by using several springs connected in series, the spring characteristic can be adapted to a desired response behavior of the valve member 55.

The spring 83 may be slipped over the guide pin 79, which extends from the cup 57, in particular from the cup base 59, in the direction of adjustment A. A passage opening 131 for the guide pin 79 may be provided on a part of the housing opposite the cup base 59 in the direction of adjustment A, in particular the cover housing part 113, into or through which the guide pin 79 projects. The passage opening 131 may be dimensioned in such a way that it guides the valve member 55 during displacement in the actuating and/or closing direction A, S.

In FIG. 6, the axial extent of the valve member collar 67, which can also be referred to as the deflector screen 67, is understood to be against the axial direction of adjustment A with the reference numeral 93. The axial dimension of the cup may be provided with the reference numeral 95. In order to determine the previously described maximum axial extension of the valve link collar 67 in relation to the axial dimension of the cup, the quotient can be formed from the axial extension 93 of the valve link collar and the axial extension 95 of the cup. As previously described, this quotient may be less than 60%, in particular less than 55% or 50%.

At least one guide lug 97 extends in the radial direction R at an upper end 80 of the guide pin 79 as viewed in the direction of adjustment A, wherein a plurality of guide lugs 97 are provided by way of example, which are arranged substantially distributed in the circumferential direction U on the guide pin 79. The guide lugs 97 serve in particular to guide the guide pin 79, in a housing of the particle separator 51, it being possible for the guide lugs 97 to engage in particular in guide grooves (not shown) provided for this purpose.

The space requirement of the spring 83, in particular in the direction of adjustment A, may be reduced in that the spring 83 may be supported on the cup 57, in particular on the cup base 59, a support point 117 being formed at a lowest position, as viewed in the direction of adjustment A, on a cup side pointing in the direction of adjustment A. Alternatively or additionally, the space requirement for the spring 83 may be reduced by the fact that the support point 117 of the spring 83 and/or the cup base 59 projects axially past the stop point 71, 77 in the closed position of the valve member 55 in the opposite direction to the actuating direction A. In this way, in particular, the total extension of the particle separator 51 required for the travel of the spring 83 can be partially displaced in the closing direction S in favor of the extension in the actuating direction A. In particular, this can also reduce the overall axial extent of an arrangement, in particular of a crankcase ventilation system 29 comprising a particle separator 51 and a gas stream source adjoining the particle separator 51 upstream, such as a crankcase from which blow-by gas streams into the separation device. In this case, advantage is taken of the fact that the displacement in favor of the axial extension in the actuating direction A in the closing direction S projects into an already available installation space of the gas stream source, so that the actuating travel of the spring 83 can be increased without reducing the overall axial extension of the arrangement.

The valve seat 73 may be rotationally symmetrical. In particular, the valve seat 73 comprises a hollow body 119 which may be shaped complementary to the cup 57 of the valve member 55. The cup 57 and/or the hollow body 119 taper in the closing direction S. In this case, the cup 57 and the hollow body 119 are shaped in particular complementarily to one another. For displacement of the valve member 55 in the closing and/or opening position, the cup 57 may be telescopically displaceable into the hollow body 119. Due to the complementary design of the cup 57 and the hollow body 119, the valve member 55 may be guided by the valve seat 73, in particular by the hollow body 119, in the actuating/closing direction A, S during displacement in the actuating/closing direction. It should be understood that some relative movement of the guided valve member 55 in a direction oriented transversely, in particular perpendicularly, to the actuating/closing direction A, S is possible. In this context, “guided” means in particular that the movement of the guided part, the valve member 55, in other directions is at least limited by the guide or that a centering of the part, the valve member 55, takes place.

As can be seen in FIG. 9, in the present arrangement there may be play in the radial direction R between the cup 57 and the hollow body 119 when the particle separator 51 is in the fully open state (shown on the left), so that the guide of the hollow body 119 allows some movement in the radial direction R. In comparison, the contact of the cup 57 with the at least one radial protrusion 76 of the hollow body 119 in FIG. 9 reduces the play present between the cup 57 and the hollow body 119 when the particle separator 51 is in the closed position (shown on the right).

The valve seat 73 further comprises a valve seat collar 121 which opens into the hollow body 119. In this case, the valve seat collar 121 extends from an end 122 of the hollow body 119, viewed in the actuating direction A, first in an arcuate manner in the radial direction R and then substantially in the closing direction S. In this case, the hollow body 119 and the valve seat collar 121 delimit an annular space 123 which is open in the closing direction S. The hollow body 119 and the valve seat collar 121 project into the annular space 115 which may be delimited by the valve member 55. In particular, the hollow body 119 and the valve seat collar 121 are enclosed by the valve member 55 in the radial direction R in the closed position.

In the particle separator 51 shown in FIG. 9 on the right, the valve member 55 and valve seat 73 are in an axially abutting contact and in a radially abutting contact in the closed state.

The radial abutting or stop contact may be formed by a radial stop contact surface 72 of the cup 57 and a radial stop contact surface 78 of the hollow body 119. For this purpose, the hollow body 119 has at least one radial projection 76 on its inner side. In this case, the radial stop contact surface 78 of the hollow body may be formed by the surface facing the cup 57 in the closed state. The radial stop contact surface 78 of the hollow body 119 may be complementary to the radial stop contact surface of the cup to form a planar radial abutment contact in the closed state. As can be seen from FIG. 9, the hollow body 119 can have a plurality of radial projections 76 offset from one another in the circumferential direction U to form the radial stop contact. In order to permit the previously described leakage flow in the closed state, the at least one radial protrusion 76 is not formed as a protrusion that is continuous in the circumferential direction, so that at least one leakage flow channel is also formed between the cup 57 and the hollow body 119 in the closed state.

The axial abutting or stop contact may be formed by an axial stop contact surface 71 of the deflector screen 67 and an axial stop contact surface 77 of the inflow housing part 111. A stop flange 125 may be formed on the inflow housing part 111 for this purpose. The surface of the stop flange 125 facing the deflecting screen in the actuating direction A forms the axial stop contact surface 77 of the inflow housing part 111. The stop flange 125 adjoins the valve seat collar 121 downstream and extends from the latter in the closing direction S, where it merges into a radial web 125 of the inflow housing part 111. The axial stop contact surface 71 of the deflector shield 67, may be formed by its side facing the stop flange 127 in the closing direction. The deflector shield has a contour with projections - for forming the stop contact surface 77 - and recesses 75 - for ensuring the leakage flow in the closed state.

To form the textile receptacle 126 described above in the inflow housing part 111, the radial web 125 may be bounded downstream by an axial web 130, which extends from the radial web 125 in the actuating direction A. The axial web 130 may be located between the radial web 125 and the axial web 130. As a result, a textile receptacle 126 may be formed in the inflow housing part 111 between the stop flange 127 and the radial web 125. In an exemplary embodiment, the textile receptacle 126 delimits an annular gap 126. When using a single particle separator 51, the axial web 130 can surround the radial web 125 in the circumferential direction U for this purpose, as indicated in FIG. 8. In a particle separation system 53 with two particle separators 51, the extension of the axial web 130 in the circumferential direction can be interrupted at the sides of the particle separators 51 facing each other in the radial direction R, as shown in FIG. 9, so that the textile receptacles 126 merge into each other at this point. In the particle separator system 53 as shown in FIG. 9, an annular textile 87 may be inserted in each of the textile receptacles 126 formed in the inflow housing part 111.

The valve members 55 and valve seats 73 shown in FIG. 9 are designed to be collar-shaped, in particular telescopically introducible into one another, in such a way that a collar-shaped gap 128 may be formed between valve member 55 and valve seat 73, in particular in the closed position. The collar-shaped gap 128 may be formed in particular between flow guide surfaces 129 of the valve seat 73 and flow guide surfaces 99 of the valve member 55. In particular, the flow guide surfaces 129 of the valve seat 73 are formed by the surfaces of the hollow body 119 that are on the inside in the radial direction R and come into contact with the gas stream, and by the surface of the valve seat collar 121 that is on the outside in the radial direction R. The collar-shaped gap 128 causes the gas stream to be deflected by at least 90°, 100°, 110°, 120°, 130°, 140°, 150°, 160°, 170° or 180°, the gas stream flowing between the flow guide surfaces 99, 129 of the valve member 55 and the valve seat 73.

The separator space 115 bounded by the housing 110 may be divided by the valve member 55 into a flow space between the valve member 55 and the valve seat 73 and into a bypass space 141 between the valve member 55 and the cover part 113. The gas stream flows through the flow space along the flow guide surfaces 99, 129 between the valve seat 73 and the valve member 55. Via the contouring 74, and the passage openings 159 in the valve member 55, the gas stream can enter the bypass space 141 even in the closed position of the valve member 55, in which particles can also be separated. Due to the contouring 74 of the stop surface 71 and the passage openings 159, a gas stream can also pass from one separation device 51 to the other in the closed position of both valve members 55, and vice versa.

In addition to the textile in the inflow housing portion 111, in FIG. 9, a textile 87 may be provided in the bypass chamber 141 in an annular textile receptacle of the cover housing portion 113. In an exemplary embodiment, textile 87 in the form of tiles may be used. Particles can be deposited on the tiles. In this case, the fleece fabric 87 does not have to be flowed through. A flow against the fleeces 87 is sufficient to deposit particles thereon. The fleeces 87 are disc-shaped, in particular annular.

Downstream of the valve member 55, a separating nozzle 133 with a constant flow cross-section may be provided for atomizing and/or defined discharge of the gas stream. In particular, the separating nozzle forms at least one gap between the cover housing part 113 and the inflow housing part 111 in the assembled state. Due to a substantially immovable attachment between cover housing part 113 and inflow housing part 111, the cross-section of the gap, and thus the flow cross-section of the separator nozzle 133, remains substantially constant regardless of the position of the valve member 55. Due to the constant flow cross-section, a minimum degree of particle separation via the at least one separator nozzle 133 can be ensured even when the valve member 55 is completely open. The separator nozzle 133 may be formed downstream of the stop contact between valve member 55 and valve seat 73.

As can be seen in FIG. 9, at least two particle separators 51 can be connected fluidly so as to form a particle separation system 53 in such a way that a gas stream from one particle separator 51 can pass into the other particle separator 51. In particular, the particle separators 51 are in fluid communication with each other downstream of the separation nozzle 133. An exemplary embodiment of such a fluidal connection is shown in FIG. 9. In this, a gas stream can leave the separation chamber 115 of one particle separator 51 via the separation nozzle 133 of the latter and enter the separation chamber 115 of the other particle separator 51 via the separation nozzle 133 of the latter.

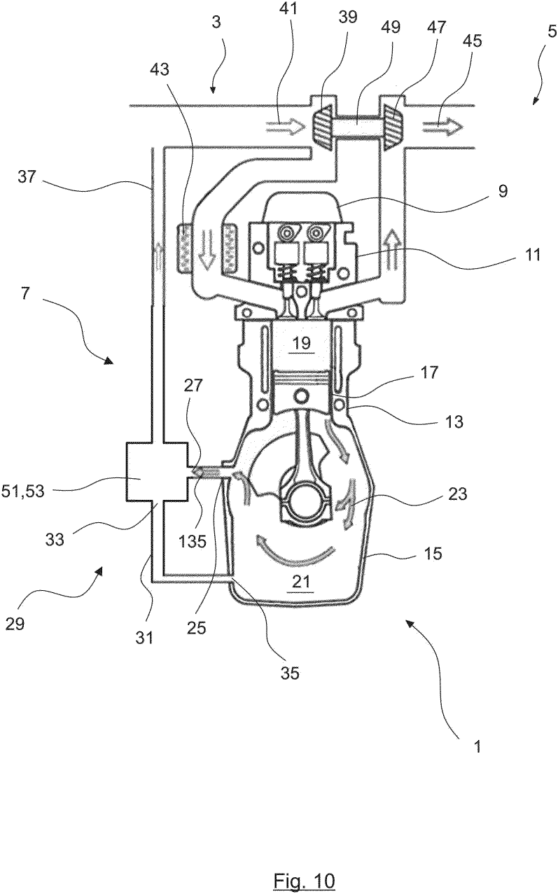

FIG. 10 shows a crankcase ventilation system 29 for a motor vehicle. The crankcase ventilation system 29 comprises a crankcase 15 with a flow outlet opening 25 for discharging blow-by gas from the crankcase 15 and a particle separator 51 according to the disclosure, which is fluidly connected to the flow outlet opening 25 and is schematically indicated in FIG. 10. Alternatively, to the particle separator 51, a particle separation system 53 according to the disclosure can be fluidly coupled to the flow outlet opening 25 to form a crankcase ventilation system 29. As shown in FIG. 10, the fluid connection between the particle separator 51 and the flow outlet opening 25 may be implemented via a piping system, such as an outlet line 135, which forms a fluid connection of the flow outlet opening 25 of the crankcase 15 with the gas stream inlet 27 of the particle separator 51. Alternatively, the particle separator 51 can be mounted to the crankcase 15 in such a way (not shown) that the gas stream inlet 27 of the separator 51 corresponds to the flow outlet opening 25 of the crankcase 15.

Furthermore, FIG. 10 shows a possible integration of the crankcase ventilation system 29 in a motor vehicle with an internal combustion engine. The internal combustion engine 1 comprises a cylinder head cover 9, a cylinder head 11, a cylinder 13 and a crankcase 15, which may be in fluidic connected with the crankcase ventilation system 29 via its flow outlet opening 25, forming the crankcase ventilation system 29 as described above. A piston 17 may be guided in the cylinder 13, which delimits a displacement chamber 19 with respect to a crankcase interior 21. Sealing rings not shown may be provided between the piston 17 and the cylinder 13 to seal the displacement 19 with respect to the crankcase interior 21. Nevertheless, combustion gases and/or unburned gases flow between piston 17 and cylinder 13 from the displacement chamber 19 into the spherical housing interior 21. The resulting gas stream 23 is also referred to as a blow-by gas stream and includes combustion gases and unburned fuel components in addition to air and oil.

To prevent a pressure increase in the crankcase 15 due to blow-by gases accumulating therein, the gas stream 23 may be discharged via the crankcase ventilation system 29. The particle separator 51 may be connected to the crankcase 15 via a return line 31 to return separated oil to the crankcase 15. For this purpose, the return line 31 fluidically connects a return outlet 33 of the particle separator 51 to a return inlet 35 of the crankcase 15. Via a return line 7, the gas stream cleaned of oil may be supplied to a fresh air supply 3 of the internal combustion engine 1. The resulting fresh air stream 41 may be compressed by a compressor wheel 39 and fed to the internal combustion engine 1 via the cylinder head 11 via an intercooler 43. Combustion gases that do not enter the crankcase 15 between piston 17 and cylinder 13 are fed as exhaust gas 45 via an exhaust outlet 5 to a turbocharger 47, which drives compressor wheel 39 in fresh air supply 3 via a shaft 49.

It should be made clear that the installation position of the particle separator 51 according to the disclosure when used as an oil separator, in particular in motor vehicles, is not limited to the installation position shown in FIG. 10, nor is it limited to use in a crankcase ventilation system 29. For example, the particle separator 51 can also be used to separate particles from gas streams exiting the internal combustion engine 1 between cylinder 13 and cylinder head 11 and/or between cylinder head 11 and cylinder head cover 9. Another possible area of application is in the fresh air supply 3 and/or in the exhaust gas discharge 5, which can be fluidly coupled to one another in particular via the shaft 49 connecting the compressor wheel 39 and the turbine wheel 47.

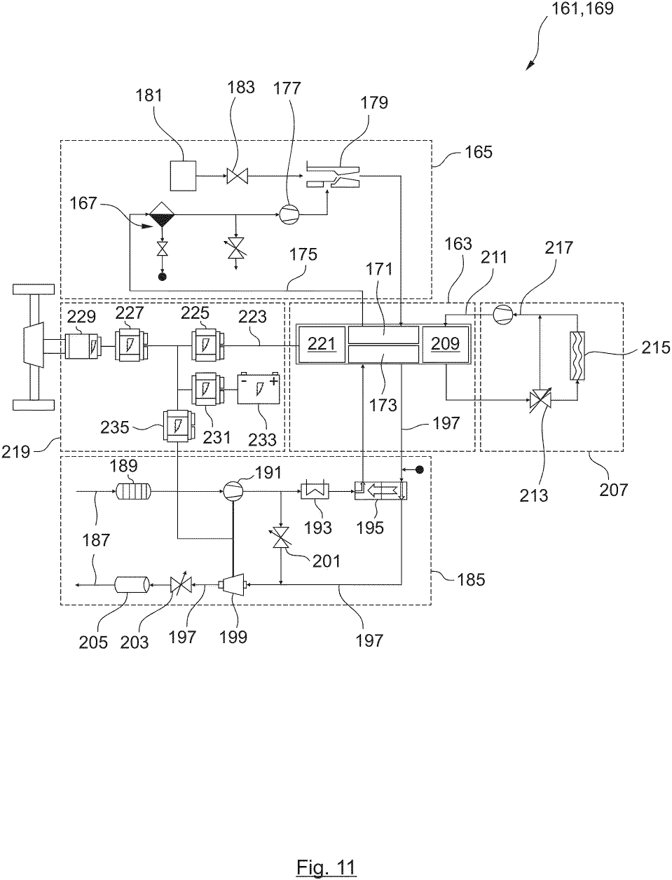

FIG. 11 shows an exemplary embodiment of a fuel cell vehicle 169 according to the disclosure with a fuel cell system 161 according to the disclosure as a circuit diagram. The fuel cell system 161 comprises a fuel cell 163 and a particle-carrying conduit system 165, in which a particle separator according to the disclosure in the form of a water separator is indicated schematically by reference numeral 167. The fuel cell has an anode 171 and a cathode 173. A gas stream 175 exiting from the anode 171 is supplied to the water separator 167. Part of the moisture, in particular water, separated by water separator 167 may be then fed back to the anode via a recirculation pump 177 and an ejector 179 connected thereto, in particular to achieve water wetting on the surface of the fuel cell. In this process, the efficiency of the fuel cell 163 can be increased or decreased depending on the amount of water and the amount of gas. In addition, hydrogen may be supplied to the ejector 179 from a hydrogen tank 181 via a pressure reducer 183.

On the cathode side, the fuel cell system 161 has an oxygen supply 185. This feeds air from the environment 187 via an air filter 189 to a compressor 191, from where the air is fed to the cathode 173 via an intercooler 193 and a humidifier 195. Gases 197 escaping from the cathode are removed via the humidifier 195. In the process, water may be transferred from the gas stream exiting the cathode to the gas stream entering the cathode. Downstream of the humidifier, the cathode exhaust gas stream 197 may be fed to a turbine 199 through which the compressor 191 is driven. Prior to entering the turbine 199, fresh air may be supplied to the cathode exhaust gas stream via a stack bypass valve 201. Downstream of the turbine 199, the cathode exhaust gas stream 197 may be discharged back to the environment 187 via a throttle valve 203 and a silencer 205.

Further, the fuel cell system 161 includes a cooling system 207. This supplies a cooling medium 211 to a corresponding interface 209 of the fuel cell 163. The fuel cell 163 may be cooled via the cooling medium 211. When the cooling medium 211 exits the fuel cell 163, it may be fed to a heat sink 215 via a three-way valve 213 and may be fed back from the heat sink 215 to the interface 209 via a cooling pump 217. The three-way valve 213 can be used to partially or fully bypass the heat sink 215.

In order to use the previously described fuel cell system 22 on a fuel cell vehicle 169, the fuel cell 163 may be coupled to an electrical system 219 to provide traction power to the fuel cell vehicle 169. For this purpose, via an interface 221 to the electrical system 219, electrical energy 223 from the fuel cell 163 may be supplied via a fuel cell boost converter 225 and an inverter 227 to an electric motor 229 that provides the traction drive power to the fuel cell vehicle 169. If required, a battery 233 with battery converter 231 can be connected. Further, if required, the electrical system 219 may be coupled to the compressor 191 and turbine 199 of the oxygen supply 185 via a compressor inverter 235.

The features disclosed in the foregoing description, figures, and claims may be significant both individually and in any combination for the realization of the disclosure in the various embodiments.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Reference List

| | |
|---|---|
| 1 | combustion engine |
| 3 | fresh air supply |
| 5 | exhaust gas discharge |
| 7 | return line |
| 9 | cylinder head cover |
| 11 | cylinder head |
| 13 | cylinder |
| 15 | crankcase |
| 17 | piston |
| 19 | displacement |
| 21 | crankcase interior |
| 23 | gas stream |
| 25 | flow outlet opening |
| 27 | gas stream input |
| 28 | gas stream output |
| 29 | crankcase ventilation system |
| 31 | return line |
| 33 | return outlet |
| 35 | return inlet |
| 39 | compressor wheel |
| 41 | fresh air flow |
| 43 | intercooler |
| 45 | exhaust |
| 47 | turbocharger |
| 49 | shaft |
| 51 | particle separator |
| 53 | particle separation system |
| 55 | valve member |
| 57 | cup |
| 59 | cup base |
| 61 | jacket |
| 63 | maximum inner diameter of the jacket |
| 65 | minimum inner diameter of the jacket |
| 67 | deflection shield / valve link collar |
| 69 | ring space between cup and valve member collar |
| 71 | axial stop contact surface of the valve member/diverting screen |
| 72 | radial stop contact surface of the valve member / cup |
| 73 | valve seat |
| 74 | contouring |
| 75 | deepening a contour |
| 76 | radial protrusion of the hollow body |
| 77 | axial stop contact area of the inflow housing part/valve seat |
| 78 | radial stop contact area of the inflow housing part/valve seat/hollow body |
| 79 | guide pin |
| 80 | end |
| 83 | spring |
| 82, 84 | axial end |
| 87 | textile/fleece |
| 93 | axial extension of the valve collar |
| 95 | axial extension of the bowl |
| 97 | guide nose |
| 99 | flow guide surfaces of the valve member |
| 110 | Housing |
| 111 | inflow housing part |
| 113 | lid housing part |
| 115 | separator room |
| 117 | support point of the spring on the valve member |
| 119 | hollow body |
| 121 | valve seat collar |
| 122 | end |
| 123 | ring space between hollow body and collar of valve member |
| 125 | radial bar |
| 126 | textile pickup / annular gap |
| 127 | stop flange |
| 128 | collar-shaped gap |
| 129 | flow guide surface of the valve seat |
| 130 | axial bar |
| 131 | passage opening for guide pin |
| 133 | separator nozzle |
| 135 | outlet line |
| 141 | bypass room |
| 159 | opening / gas stream divider |
| 160 | ring stop |
| 161 | fuel cell system |
| 163 | fuel cell |
| 165 | conduit system |
| 167 | water separator |
| 169 | fuel cell vehicle |
| 171 | anode |
| 173 | cathode |
| 175 | anode current |
| 177 | recirculation pump |
| 179 | ejector |
| 181 | hydrogen tank |
| 183 | pressure reducer |
| 185 | oxygen supply |
| 187 | environment |
| 189 | air filter |
| 191 | compressor |
| 193 | intercooler |
| 195 | humidifier |
| 197 | cathode exhaust gas stream |
| 199 | turbine |
| 201 | stack bypass valve |
| 203 | throttle valve |
| 205 | silencer |
| 207 | cooling system |
| 209 | interface for cooling in fuel cell |
| 211 | cooling medium |
| 213 | three-way valve |
| 215 | heat sink |
| 217 | cooling pump |
| 219 | electrical system |
| 221 | interface to electrical system in fuel cell |
| 223 | electric energy generated by fuel cell |
| 225 | fuel cell boost converter |
| 227 | inverter |
| 229 | electric motor |
| 231 | battery converter |
| 233 | battery |
| 235 | compressor Inverter |
| A | actuating direction / inflow direction |
| S | closing direction |
| R | radial direction |
| U | Umfangsrichtung |
| B | rotation symmetry axis |

1. A particle separator for cleaning a gas stream loaded with particles, comprising:
a gas stream inlet at which the gas stream enters the particle separator with an inflow direction;
a gas stream outlet at which the gas stream leaves the particle separator, wherein the particle separator is configured to operate in:
a closed state in which gas flow from the gas stream inlet to the gas stream outlet is prevented except for a leakage flow; and
at least one opening condition in which, in addition to the leakage flow, a larger volume flow than the closed state is permitted from the gas stream inlet to the gas stream outlet;
a deflection guide channel, arranged between the gas stream inlet and the gas stream outlet, configured to deflect the large volume flow and/or the leakage flow by at least 90° with respect to the inflow direction; and
a textile arranged such that at least part of the deflected large-volume flow and/or the deflected leakage flow impinges on the textile.

2. The particle separator according to claim 1, wherein the deflection guide channel is configured to deflect the large volume flow and/or the leakage flow by at least 100° with respect to the inflow direction.

3. The particle separator according to claim 1, wherein the particle separator is configured to be in the closed state up to a volume flow of 30 l/min of the gas stream to be cleaned.

4. A particle separator for cleaning a gas stream loaded with particles, comprising:
a gas stream inlet at which the gas stream enters the particle separator;
a gas stream outlet at which the gas stream leaves the particle separator;
a conduit arranged between the gas stream inlet and the gas stream outlet; and
a textile, arranged in the conduit, the textile including a coating configured to reduce adhesion of particles to the textile.

5. The particle separator according to claim 4, wherein the coating is sprayable or printable coating, and/or wherein the coating is a silane-based solution.

6. The particle separator according to claim 4, wherein the textile comprises a polyester material.

7. A particle separator for cleaning a gas stream loaded with particles, comprising:
a gas stream inlet at which the gas stream enters the particle separator with an inflow direction;
a gas stream outlet at which the gas stream leaves the particle separator;
a gas stream divider configured to divide the gas stream into at least two partial gas streams, in particular into a leakage flow and a large-volume flow;
a deflection guide arranged downstream of the gas stream divider and configured to deflect one of the at least two partial gas streams more strongly than at least one other of the at least two gas streams;
a first textile arranged such that at least a portion of the more strongly deflected gas stream impinges on the first textile; and
a second textile arranged such that at least a portion of the less strongly deflected gas stream impinges on the second textile.

8. The particle separator according to claim 7, wherein the deflection guide is configured to deflect the more strongly deflected partial gas stream by at least 90° with respect to the inflow direction.

9. The particle separator according to claim 7, wherein the gas stream divider and/or the deflection guide are formed at least in sections by a movable valve member configured to adjust a volume flow passing through the particle separator, the valve member being biased into a closed state.

10. The particle separator according to claim 7, further comprising:
a valve seat defining the gas stream inlet; and
a valve member configured to be displaceable between a closed position, in which the valve member is brought into abutting contact with the valve seat, and at least one open position, in which the valve member is moved out of abutting contact in an axial actuating direction, the valve member having a rotational cup facing the gas stream to be cleaned.

11. The particle separator according to claim 10, wherein the valve member comprises a rotationally-shaped deflecting screen adjoining the rotational cup, the rotationally-shaped deflecting screen being configured to deflect the gas stream in the direction of the first textile in the at least one opening position, wherein the deflecting screen is configured to deflect the gas stream by at least 90° with respect to the inflow direction.

12. The particle separator of claim 11, wherein the rotationally-shaped deflecting screen extends axially against the axial direction of adjustment by less than 60% of an axial dimension of the rotational cup.

13. The particle separator according to claim 10, further comprising:
an inflow housing comprising the valve seat and a first textile receptacle for the first textile; and
a cover housing opposite the inflow housing and having a second textile receptacle for the second textile.

14. The particle separator according to claim 13, wherein the first textile receptacle of the inflow housing is dimensioned and/or arranged such that one of the two partial gas streams flows towards the textile receptacle.

15. The particle separator according to claim 13, wherein the valve member is movable and/or dimensioned such that the valve member is free from abutment contact with the first textile, the inflow housing having, adjacent to the first textile receptacle, an abutment flange with which the valve member is configured to selectively come into abutment contact.

16. A particle separation system comprising at least two particle separators according to claim 7 and configured to clean a gas stream loaded with particles, wherein the particle separators are in fluid communication with each other.

17. The particle separation system according to claim 16, wherein the at least two particle separators are fluidly connected to each other such that the gas stream to be cleaned is dividable into the at least two particle separators upstream of the particle separation system and/or a gas stream from one particle separator is passable into at least one further particle separator.

18. A method for cleaning a gas stream of particles, the method comprising:
providing a particle separator configured to cleaning the gas stream, the particle separator including:
a gas stream inlet at which the gas stream enters the particle separator with an inflow direction;
a gas stream outlet at which the gas stream leaves the particle separator;
a gas stream divider configured to divide the gas stream into at least two partial gas streams, in particular into a leakage flow and a large-volume flow;
a deflection guide arranged downstream of the gas stream divider and configured to deflect one of the at least two partial gas streams more strongly than at least one other of the at least two gas streams;
a first textile arranged such that at least a portion of the more strongly deflected gas stream impinges on the first textile; and
a second textile arranged such that at least a portion of the less strongly deflected gas stream impinges on the second textile; and
introducing the gas stream into the particle separator to clean the gas stream.

19. The method according to claim 18, wherein the particle separator is configured to remain in a closed state up to a gas stream of 30 l/min, be brought into a partially open state at a gas stream of more than 30 l/min and at most 70 l/min, and/or be brought into a fully open state from a gas stream of more than 70 l/min.

20. The method of claim 19, wherein the particle separator is displaced between the closed state and the at least one open state in response to the gas stream volume.

21. A fuel cell system for a motor vehicle, comprising a fuel cell and a particle separator according to claim 7, the particle separator arranged in a particle-carrying conduit system carrying a particle-laden gas stream from the fuel cell.

22. A fuel cell vehicle comprising a fuel cell system according to claim 21.

23. A crankcase ventilation system for a motor vehicle, comprising a crankcase having a flow exit port for removing blow-by gases from the crankcase, and a particle separator according to claim 7, the particle separator being in fluid communication with the flow exit port for cleaning the blow-by gases from oil particles.
